(19) United States
(12) Patent Application Publication
(10) Pub. No.: US 2020/0071538 A1
(43) Pub. Date: Mar. 5, 2020

(54) SEALABLE ANTI-CORROSION COATING FOR PACKAGING FILM FOR AGGRESSIVE PRODUCTS

(71) Applicant: Constantia Pirk GmbH & Co. KG, Pirk (DE)

(72) Inventors: Thomas KESMARSZKY, Weiherhammer (DE); Markus KICK, Weiden in der Oberpfalz (DE)

(73) Assignee: Constantia Pirk GmbH & Co. KG, Pirk (DE)

(21) Appl. No.: 16/493,748

(22) PCT Filed: Mar. 13, 2018
(86) PCT No.: PCT/EP2018/056190

§ 371 Date: Sep. 12, 2019

(30) Foreign Application Priority Data
Mar. 13, 2017 (AT) A50195/2017

(51) Int. Cl. C09D 5/08; C08L 57/00; C08L 87/00; C08K 3/32; C08K 5/092; C08K 5/42

(52) U.S. Cl. CPC C09D 5/08; C08L 57/00; C08L 87/00; C08K 3/32; B65D 65/38; C08K 5/42; C08L 2203/162; C08K 2003/329; C08K 5/092

(57) ABSTRACT

A sealable anti-corrosion coating for packaging films for packaging aggressive products such as perfumed cream, oil, fat emulsion, acidic or alkaline detergents, alcoholic products, especially aluminum-based plates with which cups or containers filled with such goods are sealed. The coating includes:
a) one or more solvents,
b) one or more reactive binding agents,
e) one or more sealing components and
f) one or more acid catalysts.

The resulting aluminum foil is suitable for packaging aggressive goods, achieving both corrosion protection and high seal strength.

The invention relates to a sealable anti-corrosion coating for packaging films for packaging for aggressive products and especially for aluminum-based plates with which cups or containers filled with such goods are sealed, according to the preamble of claim 1.

From WO 2009/013064 A2, coatings for metallic, mineral or substrates of wood, paper, plastic containing yellowing-resistant, low-viscosity, unsaturated, amorphous polyesters are known and which are largely free of benzene or formaldehyde. They adhere well to their substrates, even in critical climatic conditions. For applications according to the invention, these compositions are neither suitable nor approved.

For similar applications for metallic surfaces in outdoor or corrosive environments, US 2008/0268162 A1 discloses the application of special silanes and their curing on the surface. This also is neither suitable nor permitted for applications according to the invention.

DE 10 2005 024 246 A1 describes in detail, but without mentioning special fields of application, copolymers based on special acrylate monomers for use in adhesives and coatings.

WO 2006/050915 A2 describes a process for coating metallic surfaces with an aqueous composition of many components. It also is about solid metal surfaces in an outdoor environment (e.g. vehicle bodies); the composition contains at least silanes, siloxanes, titanium compounds, various cations, amino or urea groups, nitro groups and more and is also neither suitable nor approved for applications according to the invention.

DE 36 30 954 A1 (SIEMENS) relates to photopolymers for use as protective and insulating layers in the field of circuit technology.

If a container with aggressive products such as perfumed cream, oil, fat emulsions, acidic or alkaline detergents, alcoholic products, etc. is closed with an aluminum foil which is sealed against the edge of the container, it is necessary on the product facing side of the aluminum foil to apply an anti-corrosion agent, on which in a second step a heat sealing coating is applied. In many cases, to which the invention relates, these layers are applied “in two coats”, for example by means of dip coating, powder coating, spray painting. Here it is necessary that the anti-corrosion agent, also called anti-corrosive primer, is strongly crosslinked in order to ensure a good corrosion protection effect. This leads to the problem that the subsequently applied heat sealing coating is not very firmly anchored on the primer surface. As a result, the achievable level of the strength of the seal seam, for example against a polypropylene material which the cup often consists of, is only small.

There is thus a need for a packaging film comprising an aluminum foil which can be used as a packaging material for aggressive goods, in which both the corrosion protection is sufficiently ensured and high seal strengths can be achieved.

The object of the invention is to provide such a packaging film and to make it available.

According to the invention, these objects are achieved with a packaging film having the features specified in the characterizing part of claim 1. In other words, a coating material is applied in a single stroke, segregating during the drying process, wherein the constituent developing the anti-corrosive effect concentrates and adheres to the aluminum, and wherein the constituent contributing the heat sealing ability concentrates on the free surface or adjacent to it.

The invention is explained in more detail below with reference to the examples, starting from a standard paint according to the state of the art. All percentages stated in the specification and claims, insofar as they refer to amounts, are % by weight.

Comparative Example:

This standard paint according to the state of the art consists of an epoxy resin composition containing up to 70 wt.-% of 1-methoxy-propanol, dibasic ester (DBE), e.g. a mixture of various long-chain dicarboxylic acid esters with different boiling ranges of 120° C.-200° C., depending on the application area and which a person skilled in the art may easily select, high-boiling alkanes C₁₁-C₂₀ and aromatic hydrocarbons (HC's) C₉-C₁₁, a 25 wt.-% mixture of phenol novolac resins and high molecular weight epoxy resin (MW at least 30000, consisting of formulations starting from bisphenol A (BPA), bisphenol A diglycidyl ether and 5 wt.-% of an acid-modified polypropylene copolymer mixed and homogenized in a mixer at RT for 1.5 hours. This mixture requires an application amount of at least 10 g/m² with a burn-in time of 20 s at 250° C., the surface temperature (peak metal temperature PMT) needing to reach at least 245° C.

### EXAMPLES

General Information:

The materials according to the invention comprise different contents of solvents, of reactive binding agents, of a sealing component and of an acid catalyst.

The solvents, with boiling points between 30° C. and 250° C., may be, for example, 2-butanone, methoxypropyl acetate, isopropyl acetate, 1-methoxy-propanol, dibasic ester (DBE), cyclohexane, high-boiling alkane C₁₁-C₂₀, or mixtures of at least two of these.

The reactive binding agents, with glass transition temperatures (Tg) between 0° C. and +200° C., may be, for example, reactive phenol resole resin (a reactive product of a hydroxy-crosslinked phenolic resin), phenol novolac resin, high molecular weight epoxy resin, alkylated aminoplast resins, hydroxylated copolyester, polyvinyl butyral, cellulose ester, or mixtures of at least two thereof.

The sealing component, with glass transition temperatures (Tg) between −100° C. and 100° C., contains, or consists for example of epoxy-compatible polypropylene copolymer, PP copolymer/homopolymer blend, PE/PP copolymers ethylene-vinyl acetate copolymers, amorphous Olefins or mixtures of at least two thereof.

The acid catalyst is selected from the group of inorganic acids, e.g. phosphoric acid, or from the group of organic acids, e.g. paratoluene sulfonic acid, or from citric acid, or mixtures of at least two thereof.

### Example 1

Composition consisting of:

Solvent: 64 wt.-% 1-methoxy-propanol, dibasic ester (DBE), high-boiling alkanes C₁₁-C₂₀, reactive binding agents: 15 wt .-% mixture of reactive phenol resole resins and 15 wt .-% high molecular weight epoxy resin (above 1700 g/mol), Sealing component: 5 wt.-% of an epoxy-compatible polypropylene copolymer, d=0.79 g/m³, and 1 wt.-% of an acid catalyst.

### Example 2

Composition consisting of:

Solvent: 64 wt.-% 1-methoxy-propanol, dibasic ester (DBE), high-boiling alkanes C₁₁-C₂₀, reactive binding agents: 12 wt.-% mixture of reactive phenol resole resins and 13 wt.-% high molecular weight epoxy resin,Sealing component: 10 wt.-% of an epoxy-compatible polypropylene copolymer, d=0.79 g/m³, and 1 wt.-% of an acid catalyst.

### Example 3

Composition consisting of:

Solvent: 64 wt.-% 1-methoxy-propanol, dibasic ester (DBE), high-boiling alkanes C₁₁-C₂₀, reactive binding agents: 10 wt.-% mixture of reactive phenol resole resins and 10 wt.-% high molecular weight epoxy resin

Sealing component: 15 wt.-% of an epoxy-compatible polypropylene copolymer, d=0.79 g/m³, and 1 wt.-% of an acid catalyst.

### Example 4

Composition consisting of:

Solvent: 64 wt.-% 1-methoxy-propanol, dibasic ester (DBE), high-boiling alkanes C₁₁-C₂₀, reactive binding agents: 7.5 wt.-% mixture of reactive phenol resole resins and 7.5 wt.-% high molecular weight epoxy resin

Sealing component: 20 wt.-% of an epoxy-compatible polypropylene copolymer, d=0.79 g/m³, and 1 wt.-% of an acid catalyst.

### Example 5

The following:

Solvent: 65 wt.-% 1-methoxy-propanol, dibasic ester (DBE), high-boiling alkanes C₁₁-C₂₀, reactive binding agents: 11 wt.-% f a butylated melamine resin, 8 wt.-% of a phenolic novolak resin,

Sealing component: 15 wt.-% of a PP copolymer/homopolymer blend, d=0.79 g/cm³, and 1 wt.-% of an acid catalyst are mixed and homogenized in a mixer for 1 h at RT.

### Example 6

The following:

Solvent: 18 wt.-% 1-methoxy-propanol, dibasic ester (DBE), high-boiling alkanes C₁₁-C₂₀, reactive binding agents: 46 wt.-% of a butylated melamine resin, 25 wt.-% of a high molecular weight epoxy resin, Sealing component: 15 wt.-% of a PP copolymer/homopolymer blend, d=0.79 g/cm³ and 1 wt.-% of an acid catalyst are mixed and homogenized in a mixer for 1.5 h at RT.

### Example 7

The following:

Solvent: 54 wt.-% of 1-methoxy-propanol, dibasic ester (DBE), high-boiling alkanes C₁₁-C₂₀, reactive binding agents: 25 wt.-% of a phenolic resole resin, 10 wt.-% of a thermoplastic, saturated, medium molecular weight, hydroxylated copolyester (OH number>10)

Sealing component: 15 wt.-% of a PP copolymer/homopolymer blend, d=0.79 g/cm³, and 1 wt.-% of an acid catalyst are mixed and homogenized in a mixer for 1 h at RT.

The following abbreviations apply to Tables 1 and 2:
A: Example No.
B: Reactive Binding Agents (wt.-%)
C: Sealing Component (wt.-%)
D: Mixing time (h)
E: Burn-in time (s)-Burn-in temperature (° C.)
F: Sealing seam strength (N/15 mm)
G: Corrosion resistance to greasy products
H: Assessment of phase separation by means of AFM spectroscopy

In Examples 1-7, column B is a mixing ratio of two different reactive binders in percent (the ratio in Example 5 being 46 parts of one substance and 25 parts of the other substance, the sum in this example is therefore a total of 71 wt.-% of reactive binder.

TABLE 1

| A | B | C | D | E | F | G | H |
|---|---|---|---|---|---|---|---|
| Standard | 25 | 5 | 1.5 h | 20 s, | 4-6 | After 1 | No visible |
| | | | | 245° C. | (PP) | week | phase |
| | | | | | | soft | separation |
| | | | | | | coating | |
| | | | | | | and open | |
| | | | | | | containers | |
| 1 | 15:15 | 5 | 0.5 h | 10 s, | 6-8 | After 1 | Visible |
| | | | | 220° C. | (PP) | week | phase |
| | | | | | | soft | separation |
| | | | | | | coating | |
| | | | | | | and no | |
| | | | | | | open cups | |
| 2 | 12:13 | 10 | 0.5 h | 5 s, | 8-12 | After 6 | Detectable |
| | PM | | | 220° C. | (PP) | months | clear phase |
| | | | | | | durable | separation |
| | | | | | | coating | |
| | | | | | | and no | |
| | | | | | | open cups | |
| 3 | 10:10 | 15 | 0.3 h | 5 s, | >15 | After 6 | Detectable |
| | AM | | | 220° C. | (PP) | months | clear phase |
| | | | | | | durable | separation |
| | | | | | | coating no | |
| | | | | | | open cups | |
| 4 | 7.5:7.5 | 20 | 0.3 h | 5 s, | Firmly | After 6 | Detectable |
| | | | | 220° C. | sealing | months | clear phase |
| | | | | | (PP) | durable | separation |
| | | | | | | coating | |
| | | | | | | and no | |
| | | | | | | open cups | |
| 5 | 11:8 | 15 | 1 h | 15 s, | 5-7 | Open cups | No visible |
| | | | | 230° C. | (PP) | after 48 | phase |
| | | | | | | hrs | separation |
| 6 | 46:25 | 15 | 1.5 h | 25 s, | <4 | After 1 | Visible |
| | | | | 225° C. | (PP) | week | phase |
| | | | | | | soft | separation |
| | | | | | | coating | |
| | | | | | | and no | |
| | | | | | | open cups | |
| 7 | 25:10 | 15 | 1 h | 10 s, | No | No | Visible |
| | | | | 250° C. | sealing | assessment | phase |
| | | | | | | possible | separation |

Table 1 clearly shows that significant improvements can be achieved with the compositions according to the invention. In particular, Examples 2, 3 and 4 show high corrosion resistance, even though both burn-in temperature and burn-in time as well as mixing time were able to be shortened.

Furthermore, very good sealing values could be achieved and phase separation could be detected with AFM spectroscopy. Particularly advantageous are mixtures of 20-30 wt.-% binding agent and 10-20 wt.-% sealing component. The other examples may serve as delineation.

The standard composition, as well as Examples 1-7, relate to compositions which may only serve to seal against polypropylene. In contrast to the state of the art, it is possible for materials according to the invention to obtain, through simple changes of the composition, paints which are sealable not only against polypropylene but also against polyvinyl chloride, polystyrene and A-polyester. These are specified in Examples 8-12.

These novel paints according to the invention consist of different % by weight of solvents whose boiling points lie between +30° C. and +250° C. (2-butanone, methoxypropyl acetate, isopropyl acetate, 1-methoxy-propanol, dibasic ester (DBE), Cyclohexane, high-boiling alkanes C₁₁-C₂₀), reactive binding agents with glass transition temperatures (Tg) between 0° C. and +200° C., (acid-functional vinyl/vinyl acetate copolymer, epoxifunctional vinyl/vinyl acetate copolymer, hydroxy-functional vinyl/vinyl acetate copolymer, PP copolymer/homopolymer blend, partially acid-modified, polyvinyl butyral, cellulose ester), a sealing component with glass transition temperatures (Tg) firstly between −80 and −60° C. and secondly between +30 and +100° C., (a dispersion of methacrylic acid ester/olefin copolymers) and an acid catalyst, as shown in the following examples.

The acid catalyst is selected from the group of inorganic acids, e.g., phosphoric acid, or organic acids, e.g. paratoluene sulfonic acid, or citric acid or any mixtures.

### Example 8

67.3 wt.-% 2-butanone, methoxypropyl acetate, isopropyl acetate, 1-methoxy-propanol, dibasic ester (DBE), cyclohexane, high-boiling alkanes C₁₁-C₂₀, 6 wt.-% of an acid-functional vinyl/vinyl acetate copolymer, 2.7 wt.-% of an epoxy-functional vinyl/vinyl acetate copolymer, 12 wt.-% of a hydroxyl-functional vinyl/vinyl acetate copolymer, 9 wt.-% of a dispersion of methacrylic acid ester/olefin copolymers and 3 wt.-% of a copolymer acid catalyst are mixed and homogenized in a mixer for 30 min at RT.

### Example 9

67.3 wt.-% 2-butanone, methoxypropyl acetate, isopropyl acetate, 1-methoxy-propanol, dibasic ester (DBE), cyclohexane, high-boiling alkanes C₁₁-C₂₀, 6 wt.-% of an acid-functional vinyl/vinyl acetate copolymer, 6.7 wt.-% of an epoxy-functional vinyl/vinyl acetate copolymer, 8 wt.-% of a hydroxyl-functional vinyl/vinyl acetate copolymer, 9 wt.-% of a dispersion of methacrylic acid ester/olefin copolymers and 3 wt.-% of a copolymer acid catalyst are mixed and homogenized in a mixer for 30 min at RT.

### Example 10

67.3 wt.-% 2-butanone, methoxypropyl acetate, isopropyl acetate, 1-methoxy-propanol, dibasic ester (DBE), cyclohexane, high-boiling alkanes C₁₁-C₂₀, 6 wt.-% of an acid-functional vinyl/vinyl acetate copolymer, 10.7 wt.-% of an epoxy-functional vinyl/vinyl acetate copolymer, 4 wt.-% of a hydroxyl-functional vinyl/vinyl acetate copolymer, 9 wt.-% of a dispersion of methacrylic acid ester/olefin copolymers and 3 wt.-% of a copolymer acid catalyst are mixed and homogenized in a mixer for 30 min at RT.

### Example 11

67.3 wt.-% 2-butanone, methoxypropyl acetate, isopropyl acetate, 1-methoxy-propanol, dibasic ester (DBE), cyclohexane, high-boiling alkanes C₁₁-C₂₀, 6 wt.-% of an acid-functional vinyl/vinyl acetate copolymer, 14.7 wt.-% of an epoxy-functional vinyl/vinyl acetate copolymer, 9 wt.-% of a dispersion of methacrylic acid ester/olefin copolymers and 3 wt.-% of an acid catalyst are mixed and homogenized in a mixer for 30 min at RT.

### Example 12

86 wt.-% of high-boiling alkanes C₁₁-C₂₀, 14 wt.-% of a PP copolymer/homopolymer blend, partially acid-modified, d=0.79 g/cm³, are homogenized in a mixer for 30 min at RT.

Explanatory notes to the following Table 2:

In the standard case, only one binding agent with x=25 wt.-% is present in the formulation; in Example 12, 0 wt.-% binding agent is included in the formulation.

In Example 11, two binding agents with 6 parts and 14.7 parts and thus with a total of: x+y=20.7 wt.-% are included in the formulation.

In Examples 8-10, 3 binding agents included in the formulation, e.g. in Example 7 with 6 parts, 2.7 parts, and 12 parts, thus in a total amount of x+y +z=20.7 wt.-%.

TABLE 2

| A | B | C | D | E | F | G | H |
|---|---|---|---|---|---|---|---|
| Standard | 25 | 5 | 1.5 h | 20 s, | 4-6 | After 1 | No |
| | | | | 245° C. | (PP) | week soft | visible |
| | | | | | | coating | phase |
| | | | | | | and open | separation |
| | | | | | | containers | |
| 8 | 6:2.7:12 | 9 | 0.5 h | 10 s, | >12 | After 6 | Detectable |
| | | | | 210° C. | (PP; | months | clear |
| | | | | | PVC, | durable | phase |
| | | | | | PS, | coating | separation |
| | | | | | APET) | and no | |
| | | | | | | open cups | |
| 9 | 6:6.7:8 | 9 | 0.5 h | 5 s, | 8-10 | After 6 | Detectable |
| | | | | 220° C. | (PP, | months | clear |
| | | | | | PVC, | durable | phase |
| | | | | | PS, | coating | separation |
| | | | | | APET) | and no | |
| | | | | | | open cups | |
| 10 | 6:10.7:4 | 9 | 0.5 h | 5 s, | <5 | After 1 | No |
| | | | | 220° C. | (PP, | week soft | visible |
| | | | | | PVC, | coating | phase |
| | | | | | PS, | and open | separation |
| | | | | | APET) | containers | |
| 11 | 6:14.7 | 9 | 0.5 h | 15 s, | <5 | After 48 h | No |
| | | | | 230 ° C. | (PP, | open | visible |
| | | | | | PVC, | cups | phase |
| | | | | | PS, | | separation |
| | | | | | APET) | | |
| 12 | 0 | 14 | 0.5 h | 15 s, | >12 | After 48 h | homo- |
| | | | | 225° C. | (PP) | open cups | genous |
| | | | | | | | phase |

In addition to the ability to provide with these novel compositions according to the invention and in contrast to the state of the art, a seal against several cup materials (PVC, PS, A-PET), good sealing values and high corrosion resistance are achieved even at shorter mixing times and low burn-in times and temperatures, as can be seen especially in Examples 8 and 9.

Particularly advantageous are mixtures in which the ratio of the reactive binding agents in the mixture corresponds to the following:

x:y:z=4-8 wt.-%:2-10 wt.-%:8-12 wt.-%.

All other examples show conditions that are to delineate.

The coating according to the invention thus contains:
a) one or more solvents, e.g. (cyclo) alkanes, ketones, carboxylic esters, alcohols,
b) one or more reactive binding agents,
c) one or more sealing component, e.g. olefinic copolymers of ethene, propene, (iso) butene, hexene and octene & acrylic acid/olefinic copolymers, and
d) one or more acid catalysts, which herein is understood to mean a catalyst which can release at least one proton,e.g. hydrochloric acid.

More specific terms of some notations used in the specification and Claims:

Epoxide functional: highly reactive cyclic ether; hydroxy modified: provided with a hydroxyl group in one or two positions on the chemical backbone; epoxy compatible: similar polarities of both binding agents; acid-modified: provided with an acid group and with high polarity;

PP copolymer/homopolymer blend: Polypropylene homopolymer (PP-H) and copolymers (in particular provided with ethene);

Groups: Alcohol groups, cyclic ether groups, amino groups, ester groups, acetal groups.

General Information:

All quantities and proportions, insofar as they do not relate to the examples, in particular those to delineate the invention, are to be understood with a tolerance of ±10%, thus, for example: 11% means: from 9.9% to 12.1%. For terms such as: “a solvent”, the word “a” is not to denote a numerical value but a pronoun, unless otherwise stated in the context.

The term: “combination” or “combinations”, unless otherwise indicated, means all types of combinations, starting from two of the relevant constituents, to a plurality of such constituents; the term “containing” also stands for “consisting of”.

1-15. (canceled)

16. A sealable anti-corrosion coating for a packaging film, comprising:
a) one or more solvents;
b) one or more reactive binding agents;
c) one or more sealing components; and
d) one or more more acid catalysts.

17. The sealable anti-corrosion coating for a packaging film of claim 16, wherein the sealable anti-corrosion coating is used for packaging films that seal cups or containers filled with perfumed creams, oils, fat emulsions, acidic detergents, alkaline detergents, or alcoholic products.

18. The sealable anti-corrosion coating for a packaging film of claim 17, wherein the sealable anti-corrosion coating is used for packaging films that are aluminum-based films.

19. The sealable anti-corrosion coating for a packaging film of claim 16, wherein the one or more solvents include a solvent having a boiling point between +30 and +250° C.

20. The sealable anti-corrosion coating for a packaging film of claim 19, where the one or more solvents include one or more of 2-butanone, methoxypropyl acetate, isopropyl acetate, 1-methoxy-propanol, dibasic ester (DBE), cyclohexane, and high-boiling alkane C₁₁-C₂₀.

21. The sealable anti-corrosion coating for a packaging film of claim 16, wherein the one or more reactive binding agents have a glass transition temperature (Tg) between 0° C. and +200° C., and includes one or more of reactive phenol resole resins, phenol novolac resins, high molecular weight epoxy resins, alkylated melamine resins, hydroxylated copolyesters, polyvinyl butyral, and cellulose esters.

22. The sealable anti-corrosion coating for a packaging film of claim 16, characterized in that the reactive binding agent has a glass transition temperature (Tg) between −100° C. and +200° C. and includes one or more of reactive acid-modified vinyl/vinyl acetate copolymers, epoxy-vinyl/vinyl acetate copolymers, and hydroxyl-modified vinyl/vinyl acetate copolymers.

23. The sealable anti-corrosion coating for a packaging film of claim 16, wherein the one or more sealing components have a glass transition temperature (Tg) between −100° C. and +100° C. and includes one or more of an epoxy-compatible polypropylene copolymer, a PP copolymer/homopolymer blend, PE/PP copolymers, ethylene-vinyl acetate copolymers, and amorphous a-olefins.

24. The sealable anti-corrosion coating for a packaging film of claim 16, wherein the one or more sealing components includes a graft polymer, one constituent of which has a glass transition temperature (Tg) between −100° C. and +30° C., and another constituent of which has a glass transition temperature (Tg) between −80 and −60° C.

25. The sealable anti-corrosion coating for a packaging film of claim 16, wherein the one or more sealing components includes a dispersion of methacrylic ester/olefin copolymers.

26. The sealable anti-corrosion coating for a packaging film of claim 16, wherein the one or more acid catalysts includes an inorganic acid.

27. The sealable anti-corrosion coating for a packaging film of claim 26, wherein the inorganic acid is phosphoric acid.

28. The sealable anti-corrosion coating for a packaging film of claim 16, wherein the one or more acid catalysts includes an organic acid.

29. The sealable anti-corrosion coating for a packaging film of claim 28, wherein the organic acid includes one or more of paratoluene sulfonic acid and citric acid.

30. The sealable anti-corrosion coating for a packaging film of claim 16, wherein the anti-corrosion coating includes:
a) 50 to 70 wt.-% of the one or more solvents;
b) 10 to 30 wt.-% of the one or more reactive binding agents;
c) 2 to 20 wt.-% of the one or more sealing components; and
d) 0.5 to 3 wt.-% of the one or more acid catalysts.

31. The sealable anti-corrosion coating for a packaging film of claim 16, wherein the one or more reactive binding agents includes at least two different components selected from 8 to 15 wt.-% of reactive phenol resole resin, 8 to 15 wt.-% of high molecular weight epoxy resin, polyvinyl butyral, and cellulose ester, in each case measured in the finished coating.

32. The sealable anti-corrosion coating for a packaging film of claim 16, wherein the one or more reactive binding agents includes at least two different components selected from 6 to 10 wt.-% of reactive acid-modified vinyl/vinyl acetate copolymer, and 2 to 15 wt.-% of epoxy-vinyl/vinyl acetate copolymer, in each case measured in the finished coating.

33. The sealable anti-corrosion coating for a packaging film of claim 16, wherein the one or more reactive binding agents includes at least three components selected from 6 to 10 wt.-% of reactive acid-modified vinyl/vinyl acetate copolymer, 2 to 15 wt.-% of epoxy-vinyl/vinyl acetate copolymers, and 4 to 15 wt.-% of hydroxymodified vinyl/vinyl acetate copolymers, in each case measured in the finished coating.

34. The sealable anti-corrosion coating for a packaging film of claim 16, wherein the one or more sealing components include a partially acid-modified PP copolymer/homopolymer blend having a density of 0.79 g/cm³, that is present in the finished coating at 10 to 20 wt.-%, and that optionally additionally acts as a reactive binding agent.

35. The sealable anti-corrosion coating for a packaging film of claim 16, wherein the one or more sealing components includes a 5 to 15 wt.-% dispersion of methacrylic ester/olefin copolymers, as measured in the finished paint.

36. The sealable anti-corrosion coating for a packaging film of claim 16, wherein the one or more sealing components include an epoxy-compatible poly-propylene copolymer and/or PP copolymer/homopolymer blend and/or PE/PP copolymers, ethylene-vinyl acetate copolymers and/or amorphous a-olefins, in an amount of 8 to 20 wt.-%, as measured in the finished coating.
